(19) United States
(12) Patent Application Publication
(10) Pub. No.: US 2021/0233726 A1
(43) Pub. Date: Jul. 29, 2021

(54) GROUND SWITCH APPARATUS

(71) Applicant: Compass Components, Inc., Fremot, CA (US)

(72) Inventors: Michael Wallis, Fremont, CA (US); Peter Schwartz, Fremont, CA (US)

(73) Assignee: Compass Components, Inc., Fremont, CA (US)

(21) Appl. No.: 16/775,682

(22) Filed: Jan. 29, 2020

(51) Int. Cl. H01H 19/14; H01H 19/28

(52) U.S. Cl. CPC H01H 19/14; H01H 2239/018; H01H 19/28

(57) ABSTRACT

A ground switch apparatus for grounding a power source having a high voltage and/or current. The ground switch apparatus is a passive mechanical device and marine compatible, and includes components having low moisture absorption properties and corrosion resistant. The ground switch apparatus includes a grounding assembly that engages a connection mechanism to ground the power source that is electronically coupled to the ground switch. The ground switch apparatus can be configured, for example by physically moving components within the ground switch, to provide a grounded or ungrounded/open circuit configuration. To provide ground, a grounding assembly connects smoothly to a connection mechanism, for example using a pin-and-socket connection. The ground switch apparatus includes sealed components, anodized parts, and selected materials to avoid galvanic coupling and achieve marine environment compatibility.

### SUMMARY

The present technology, roughly described, provides a ground switch apparatus for grounding a power source with a high voltage and/or current. The ground switch apparatus is a passive mechanical device and marine compatible. The switch includes components having low moisture absorption properties and resistance to does not experience corrosion such as galvanic corrosion. The ground switch apparatus includes a grounding assembly that engages a connection mechanism to ground the power source that is electrically coupled to the ground switch. The ground switch apparatus can be configured, for example by physically moving components within the ground switch, to provide a grounded or ungrounded/open circuit configuration. To provide ground, a grounding assembly connects smoothly to a connection mechanism, for example using a pin-and-socket connection. The ground switch apparatus includes sealed components, anodized parts, passivated parts, and selected materials to avoid galvanic coupling and achieve marine environment compatibility. The ground switch apparatus may be used within and communicate status signals to a power distribution unit.

### BRIEF DESCRIPTION OF FIGURES

FIG. 1 is a block diagram of a ground circuit within a power distribution system.

FIG. 2 illustrates an exploded view of a ground switch apparatus.

FIG. 3 illustrates a right-side view of a ground switch apparatus.

FIG. 4 illustrates a left-side view of a ground switch apparatus.

FIG. 5 illustrates a top view of a ground switch apparatus.

FIG. 6 illustrates a bottom view of a ground switch apparatus.

FIG. 7 illustrates a front view of a ground switch apparatus.

FIG. 8 illustrates a right-back of a ground switch apparatus.

FIG. 9 illustrates a side view of a ground switch apparatus with cut-away view perspectives.

FIG. 10A illustrates a cut-away view towards the front of a ground switch apparatus.

FIG. 10B illustrates a cut-away view towards the back of a ground switch apparatus.

FIG. 11 illustrates a perspective view of a ground switch apparatus having a ground wire.

FIG. 12 illustrates a perspective view of a ground switch apparatus in a grounded configuration.

FIG. 13 illustrates a perspective view of a ground switch apparatus in an open circuit configuration.

FIG. 14 is a method for placing the ground switch apparatus in an open circuit configuration.

FIG. 15 is a method for placing the ground switch apparatus in a grounded configuration.

### DETAILED DESCRIPTION

The present technology, roughly described, provides a ground switch apparatus for grounding a power source with a high voltage and/or current. The ground switch apparatus is a passive mechanical device and marine compatible. The switch includes components having low moisture absorption properties and resistance to does not experience corrosion such as galvanic corrosion. The ground switch apparatus includes a grounding assembly that engages a connection mechanism to ground the power source that is electrically coupled to the ground switch. The ground switch apparatus can be configured, for example by physically moving components within the ground switch, to provide a grounded or ungrounded/open circuit configuration. To provide ground, a grounding assembly connects smoothly to a connection mechanism, for example using a pin-and-socket connection. The ground switch apparatus includes sealed components, anodized parts, passivated parts, and selected materials to avoid galvanic coupling and achieve marine environment compatibility. The ground switch apparatus may be used within and communicate status signals to a power distribution unit.

The ground switch apparatus is marine compatible, for example by being corrosion resistant within a saltwater air environment. The corrosion resistance is achieved with corrosion resistant materials used within the apparatus, anodized aluminum parts, passivated fasteners, sealed switches, and material selection. In some instances, materials are selected to avoid galvanic coupling. For example, materials for the apparatus may be selected to eliminate contact of dissimilar metals with each other.

The ground switch apparatus is resistant to wear compared to other switches. The ground switch apparatus provides a path from a power source to ground through a smooth-connecting grounding assembly. The circuit closing system can include a pin socket connection mechanism, wherein male pins can engage female receptor connectors. There may be one or more pin and socket pairs, such as for example three pin-socket pairs for a three-phase system.

Galvanic corrosion is eliminated due to elimination of metal to metal contact between the components of the system. For example, bushings made of electrically non-conductive material, such as plastic, are used to couple metal components of the apparatus to each other. This prevents a metal to metal connection, thereby eliminating galvanic corrosion between the metals. For example, a stainless-steel spring attached to a stainless-steel shaft is separated with an electrically non-conductive material (e.g., plastic) spool between the spring and shaft.

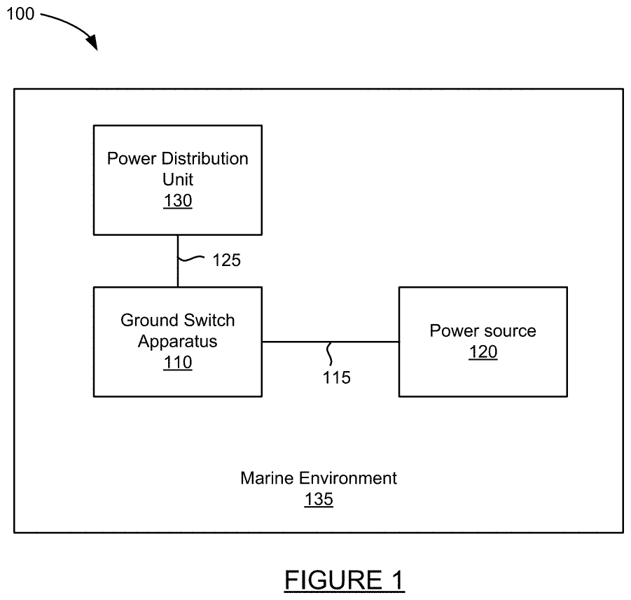

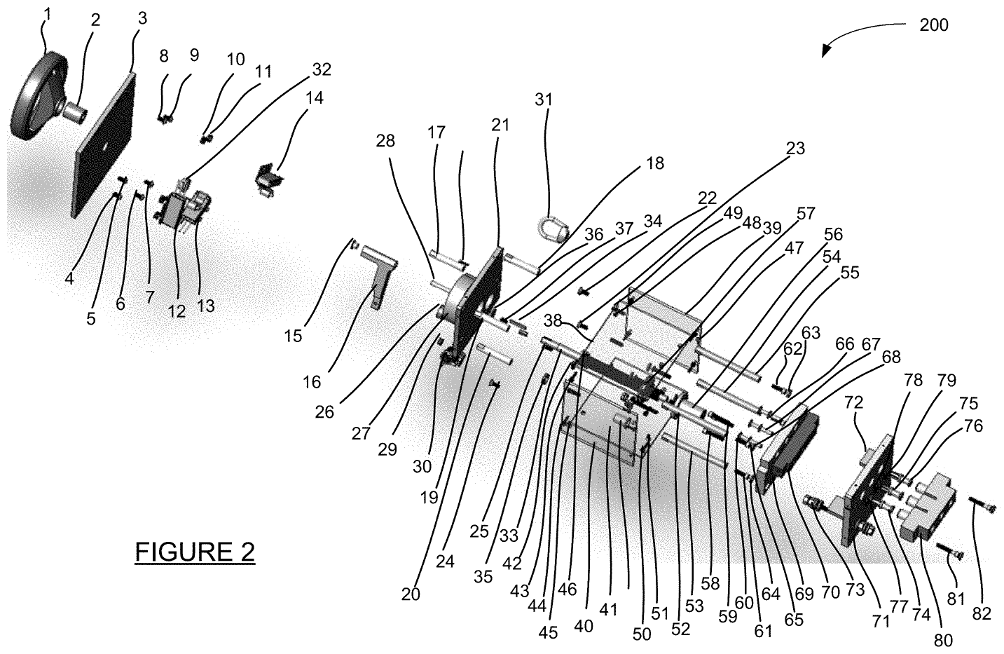

FIG. 1 is a block diagram of a grounding system within a marine environment. The system of FIG. 1 includes ground switch 110, power source 120, and power distribution unit 130, all within marine environment 135. Ground switch apparatus 110 is a passive mechanical device that provides ground to power source 120. Ground switch apparatus is discussed in more detail with respect to FIGS. 2-15.

Power source 120 may include a source of high voltage or current that can be grounded by ground switch apparatus 110. For example, the voltage may be up to 10 kilovolts, and the current may be up to 70 amps. In some instances, power source 120 can be implemented as a transformer, for example on a marine vessel such as a ship or submarine. Power source 120 may be electrically coupled to ground switch apparatus 110 via one or more wired connections 115. The ground switch apparatus 110 may ground power switch 120 to enable technicians to work on power source 120 in a safe manner.

Power distribution unit 130 may be electrically and/or physically coupled to ground switch 110. For example, LED indicators in or on power distribution unit 130 may be connected via wires 125 to sensors on or within ground switch apparatus 110. In some instances, one or more ground switch apparatus's may be implemented within power distribution unit 130. The operation of one or more ground switch apparatus's may be implemented by one or more lights, LEDs, or other indicators on power distribution unit 130, based on signals or other detectors within the one or more ground switches.

Ground switch 110, power source 120, and power distribution unit 130 may be implemented within a marine environment 135. The marine environment may include saltwater air, such as for example within a boat or submarine.

FIG. 2 illustrates an exploded view of a ground switch apparatus. The ground switch apparatus 200 of FIG. 2 provides more detail for the ground switch apparatus 110 of FIG. 1. The exploded view of ground switch apparatus 200 of FIG. 2 illustrates many components of the ground switch apparatus, though some parts of the ground switch (e.g., some screws, nuts, and other components) are not illustrated.

Table 1 includes a listing of several components included within a ground switch apparatus of the present technology. The parts listed in table 1 are illustrated in one of FIGS. 2-13, but may not all be illustrated in FIG. 2. Each component in table 1 is listed with its corresponding reference number used in FIGS. 2-13.

TABLE 1
Ground Switch Component List

| Component | |
|---|---|
| reference | |
| number | Component name |
| 1 | handwheel |
| 2 | handwheel hub |
| 3 | front plate |
| 4 | switch screw |
| 5 | switch screw |
| 6 | switch screw |
| 7 | switch screw |
| 8 | switch screw |
| 9 | switch screw |
| 10 | switch washer |
| 11 | switch washer |
| 12 | switch, snap acting |
| 13 | switch, snap acting |
| 14 | switch, snap acting |
| 15 | detent arm bearing |
| 16 | detent arm |
| 17 | short standoff |
| 18 | short standoff |
| 19 | short standoff |
| 20 | short standoff |
| 21 | middle plate |
| 22 | short standoff screw |
| 23 | short standoff screw |
| 24 | short standoff screw |
| 25 | short standoff screw |
| 26 | roller |
| 27 | cam |
| 28 | cam axle |
| 29 | spring spool |
| 30 | spring |
| 31 | eye nut |
| 32 | screw bearing |
| 33 | lead screw |
| 34 | screw key |
| 35 | spring spool |
| 36 | washer |
| 37 | screw |
| 38 | top cover |
| 39 | side cover |
| 40 | side cover |
| 41 | bottom cover |
| 42 | cover screw |
| 43 | cover screw |
| 44 | cover screw |
| 45 | cover screw |
| 46 | cover screw |
| 47 | cover screw |
| 48 | cover screw |
| 49 | cover screw |
| 50 | cover screw |
| 51 | cover screw |
| 52 | long standoff |
| 53 | long standoff |
| 54 | long standoff |
| 55 | long standoff |
| 56 | nut |
| 57 | nut ring |
| 58 | nut screw |
| 59 | nut screw |
| 60 | long standoff screw |
| 61 | long standoff screw |
| 62 | long standoff screw |
| 63 | long standoff washer |
| 64 | long standoff washer |
| 65 | long standoff washer |
| 66 | male connector |
| 67 | male connector |
| 68 | male connector |
| 69 | male contact plate |
| 70 | male contact housing |
| 71 | back plate |
| 72 | back plate shield |
| 73 | plate ground contact |
| 74 | female connector |
| 75 | female connector |
| 76 | female connector |
| 77 | set screw |
| 78 | set screw |
| 79 | set screw |
| 80 | female contact housing |
| 81 | female housing screw |
| 82 | female housing screw |
| 83 | ring washer |
| 84 | cam indent |
| 85 | female housing aperture |
| 86 | female housing aperture |
| 87 | female housing aperture |
| 88 | switch arm |
| 89 | switch arm |
| 90 | switch arm |
| 91 | switch lead |
| 92 | switch lead |
| 93 | switch lead |
| 94 | cam indent |
| 95 | cam indent |
| 96 | ground wire screw |
| 97 | ground wire |
| 98 | live wire connector |
| 99 | live wire connector |
| 100 | live wire connector |
| 101 | Open circuit position |
| | screw |
| 102 | External ground |
| | connector |
| 103 | Cam switch tab |

Handwheel 1 is coupled to front plate 3 through screw bearing 32. Switches 12, 13 and 14 are coupled to front plate 3 using switch screws and washers 4-11. The switches may be snap acting switches or some other type of switch. A cam 26 may be coupled to handwheel 1 via axle 28. The cam may also be coupled to detent arm 16, which is connected to detent arm bearing 15.

Middle plates 21 is coupled to front plate 3 by standoff components 17-20 and standoff screws. Lead screw 33 is coupled to handwheel 1 through an aperture in middle plate 21, and couplings between axle 20, detent arm 16, and detent arm bearing 15. A spring 30, spring spools 29 and 35, and roller 26 are used to engage one or more indents on cam 27 to provide detent locks at various positions of rotation along axle 28.

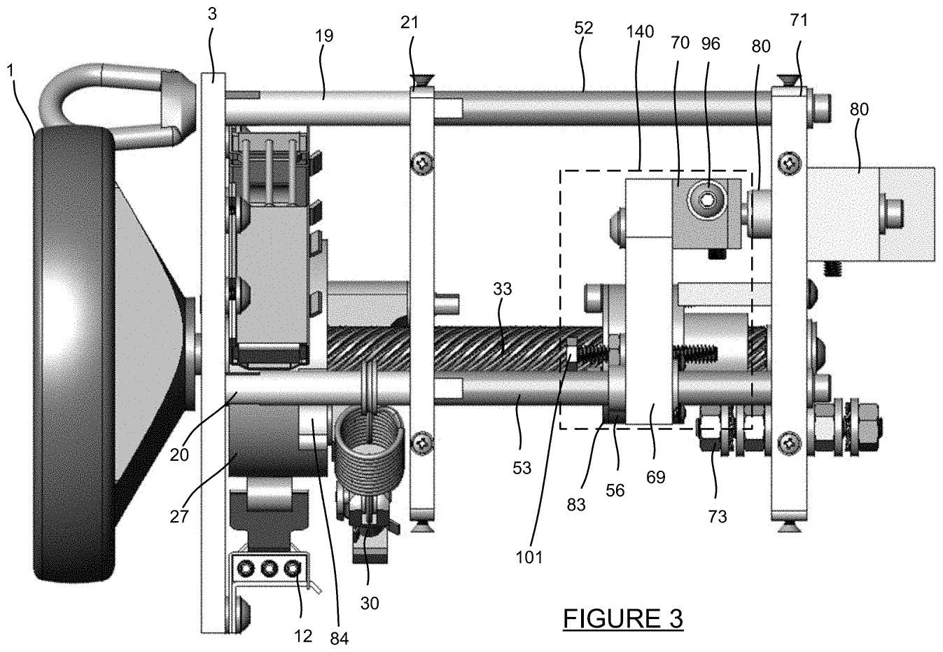

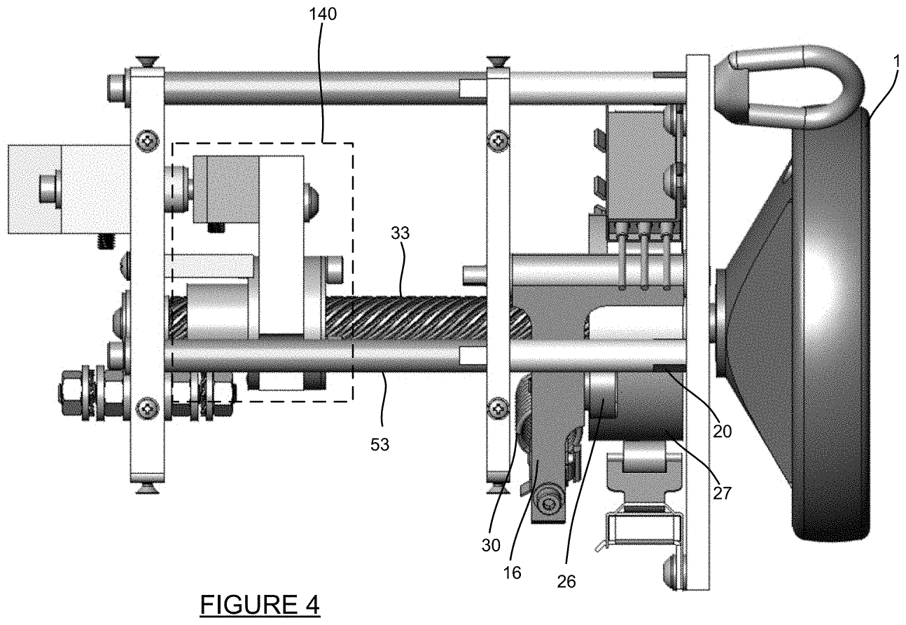

A number of components that traverse along lead screw 33 form a grounding assembly (reference no. 140 in FIGS. 3-4). The grounding assembly can include—but is not limited to—nut 56, nut ring 58, male contact plate 69, and male contact housing 70, and male connectors 66-68. The nut is coupled to nut ring 58 and male contact plate 69. The male contact plate is coupled to male contact housing 70, which in turn is coupled to male connectors 66-68.

The grounding assembly may travel along lead screw 33 via nut 56, which engages the threads of lead screw 33 to travel along lead screw 33 towards handwheel 1 or towards back plate 71, depending on the direction of rotation of the lead screw, as driven by a user that turns handwheel 1.

Back plate 78 is coupled to back plate shield 72, plate ground contact 73, female connectors 74-76, and female contact housing 80. The back plate 78 is coupled to middle plate 21 by long standoff members 52-55.

Various components of ground switch apparatus 200 of FIG. 2 are described as being coupled together. Components that are “coupled” may be connected together using screws and in some cases washers, or may be positioned near each other with another part displaced in between, such as a bushing, bearing, standoff, or some other component.

FIG. 3 illustrates a right-side view of a ground switch apparatus. The ground switch apparatus of FIG. 3 includes handwheel 1, front plate 3, three switches including switch 12, multiple short standoffs including standoff 19 and 20, cam 27, cam indent 84, spring 30, middle plate 21, multiple, long standoffs including standoffs 52 and 53, lead screw 33, nut 56, ring washer 83, male contact plate 69, male contact housing 70, ground plate contact 73, ground wire screw 96, female contact housing 80, back plate 71, and open circuit position screw 101.

Grounding assembly 140 may include portions of the ground switch apparatus that move along the threads of lead screw 33 as handwheel 1 is turned circumferentially. Some of the components of grounding assembly 140 include male contact plate 69, nut 56, nut ring 57, nut screws 58 and 59, open circuit position screw 101, male contact housing 70, and ground wire screw 96.

In some instances, when the front of the handwheel 1 is turned counter clockwise, it displaces the grounding assembly components towards the handwheel, disengaging male connector components 66-68 from female connector components 74-76, which results in an ungrounded connection to a power source coupled at female contact housing 80. The grounding assembly 140 may be displaced towards handwheel 1 along lead screw 33 until the outer surface of open circuit position screw 101 engages or touches the surface of middle plate 21. Once the screw 101 touches the surface of middle plate 21, the grounding apparatus cannot be moved any further. Additionally, a roller (not illustrated in FIG. 3) may engage indent 84 or another of one or more indents on cam 27, thereby providing a position detent for the grounding assembly 140 in a grounded or ungrounded position.

FIG. 4 illustrates a left-side view of a ground switch apparatus. The ground switch apparatus of FIG. 4 shows handwheel 1, grounding assembly 140, lead screw 33, a plurality of long standoffs including long standoff 53, detent arm 16, roller 26, a plurality of short standoffs including short standoff 20, spring 30, and cam 27.

As a user turns handwheel 1, cam 27 is caused to rotate. As the cam rotates, indents on the surface of the cam eventually are aligned with roller 26. Spring 30 applies tension to detent arm 16, which is attached to roller 26. The spring applies pressure on roller 26 against the surface of cam 27. When an indent is aligned with roller 26, the roller engages the indent and is pulled into the indent by the tension applied by spring 32 to detent arm 16. When the roller 26 engages in indent within cam 27, a “locking” action occurs, placing the grounding assembly in one of several set positions, wherein each position is associated with a cam indent. In some instances, the cam indents are associated with a first location where a power source connected to the apparatus is grounded and a second location where power source connected to the apparatus is not grounded.

The cam may include additional indents other than the ground and ungrounded position indents. For example, the cam may include a third indent associated with an engineering test or diagnostic configuration. In this configuration, for example, a subset of male connectors may be engaged with a female connector.

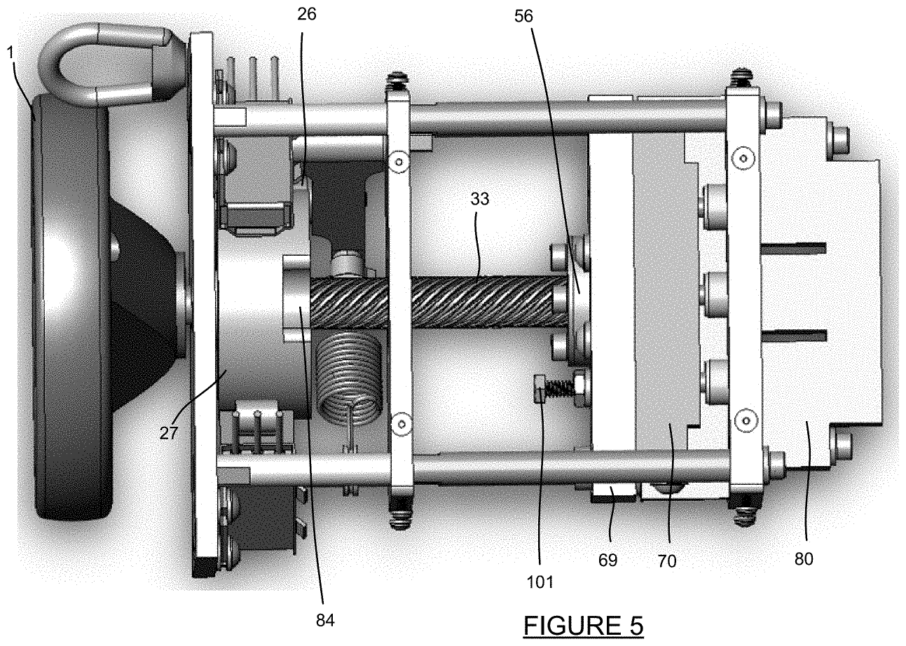

FIG. 5 illustrates a top view of a ground switch apparatus. The top view of the ground switch apparatus illustrates handwheel 1, cam 27, indent 84, roller 26, lead screw 33, nut 56, open circuit position screw 101, male contact plate 69, male contact housing 70, and female contact housing 80. As seen in the top view, when handwheel 1 is rotated, cam 27 rotates until an indent 84 reaches roller 26. As the handwheel 1 rotates, lead screw 33 rotates as well, and nut 56 causes the male contact plate 69 and male contact housing 70 of the grounding assembly to travel along screw 33. The nut 56, male contact plate 69, and male contact housing 70 are displaced towards housing wheel 1 until open circuit position screw 101 touches the middle plate. At the point where screw 101 and middle plate 21 are engaged, male connectors 66-68 are withdrawn from female connectors 74-76 and a power source connected to female contact housing 80 will not grounded. When the grounding assembly including the male contact plate 69 and male contact housing 70 are displaced away from handwheel 1, male connectors 66-68 engage and are inserted completely into female connectors 74-76, and the power source connected to female contact housing 80 is grounded.

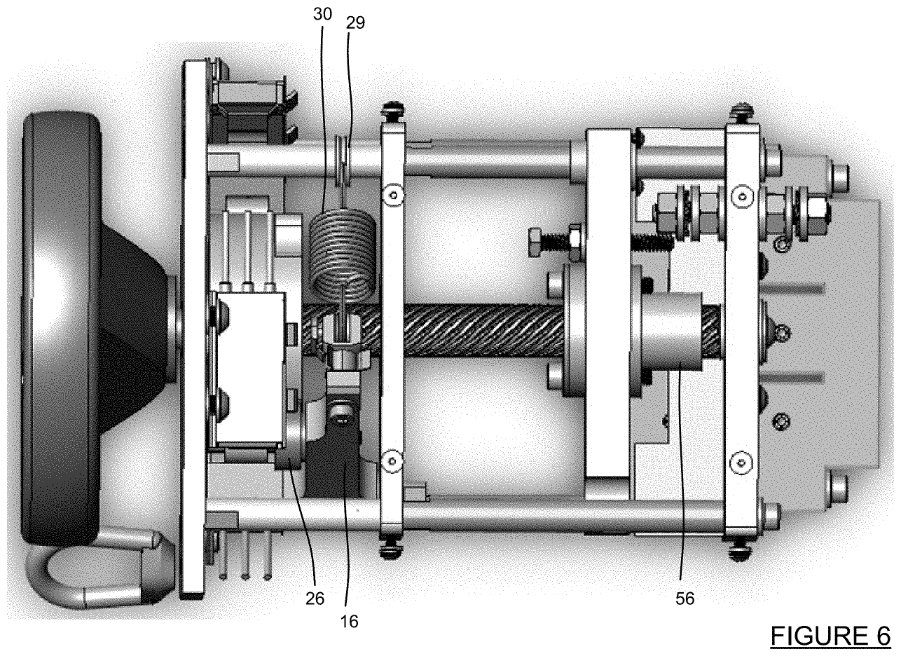

FIG. 6 illustrates a bottom view of a ground switch apparatus. The bottom view of the ground switch apparatus illustrates handwheel 1, roller 26, detent arm 16, spring 30, and spring spool 29. When handwheel 1 is rotated by a user, the cam 27 having one or more indents rotates until roller 26 engages an indent. Detent arm 16 applies pressure to roller 26 towards the surface of the cam using spring 30 and spring spool 29. The pressure applied to roller 26 achieves a detent “lock” when the indent and roller are aligned align.

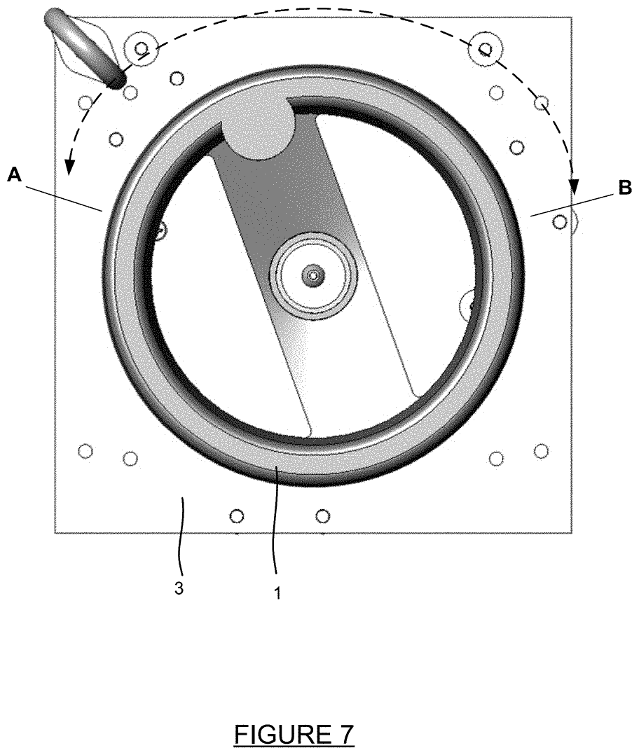

FIG. 7 illustrates a front view of a ground switch apparatus. The front view of the ground switch apparatus includes handwheel 1 and front plate 3. Handwheel 1 may be rotated in a counter clockwise or clockwise direction. In some instances, the handwheel may be rotated until a “lock” detect position is reached, based on the roller engaging a cam indent. In some instances, handwheel 1 may be rotated approximately 120° between locking detent positions, for example between position A and position B in FIG. 7.

In some instances, a greater or smaller range of motion may exist between locking positions A and B, such as for example 45, 90, 180 degrees, or some other range of motion. In some instances, more than two locking detent positions may be used. For example, there may be three indents along a cam, corresponding to a grounded position, open circuit or ungrounded position, and at least one engineering test or diagnostic position.

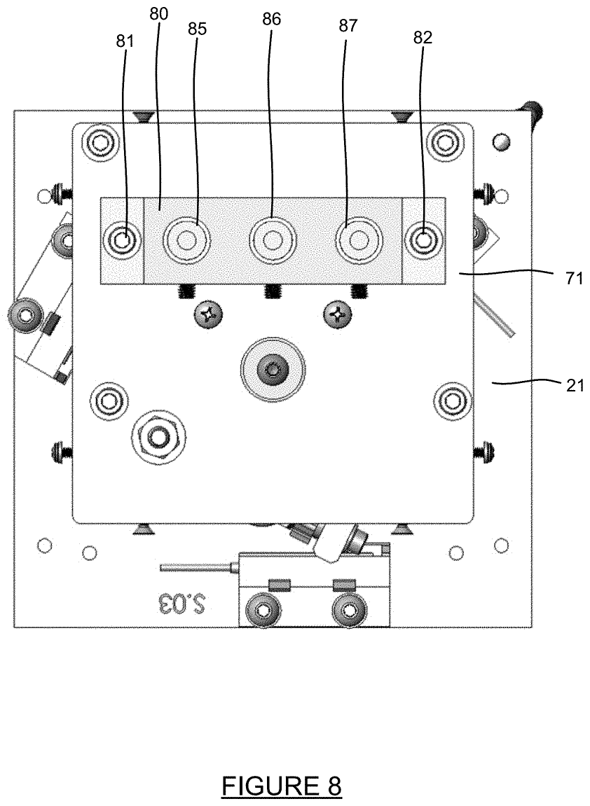

FIG. 8 illustrates a back view of a ground switch apparatus. The back view of the ground switch apparatus illustrates female contact housing 80 with housing screws 81-82 and female housing apertures 85-87. When the ground switch apparatus is coupled to a power source, the coupled may be made via a cable. The cable may have components that form electrical connection to the ground switch apparatus through the female housing apertures 85-87. Though three apertures are illustrated in the back view of the ground switch apparatus of FIG. 8, a different number of apertures may be used to implement the electrical connection. In some instances, there may be one, two, four, five, or some number of connections, and/or some other type of connection.

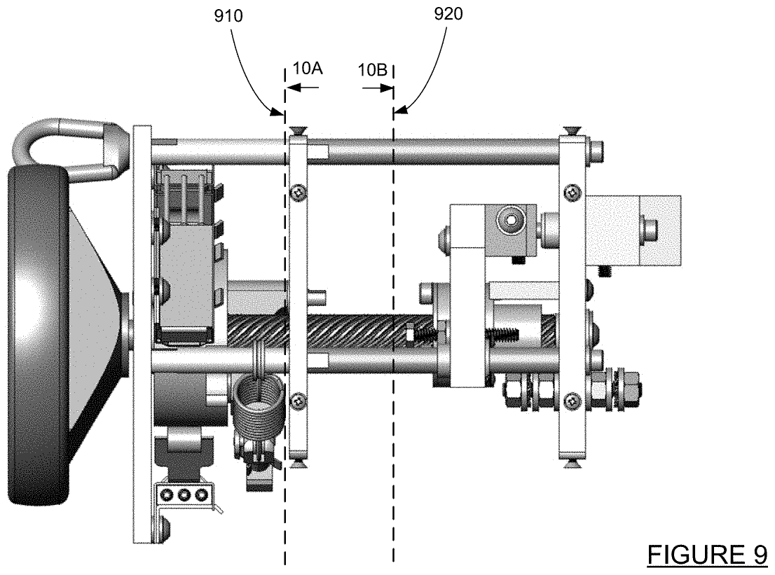

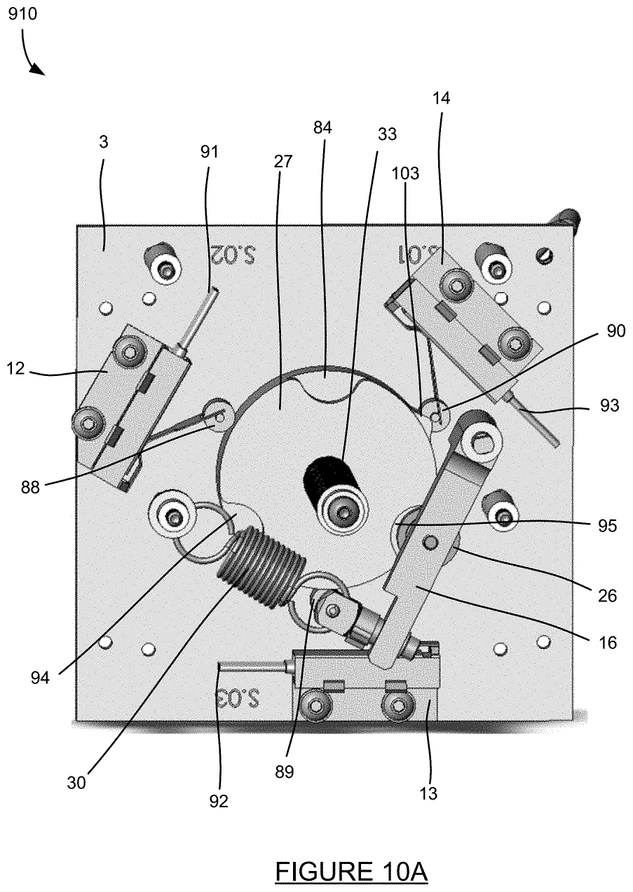

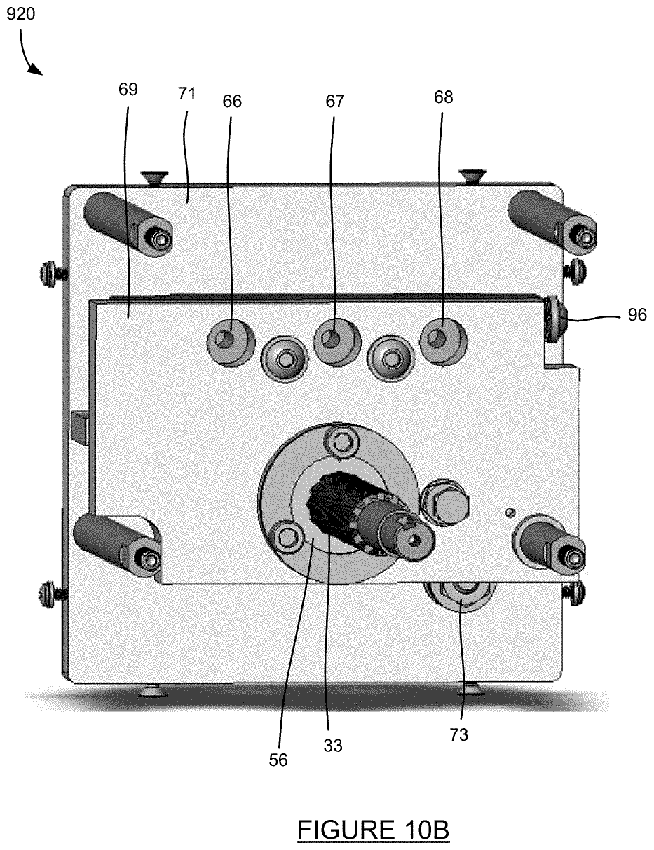

FIG. 9 illustrates a side view of a ground switch apparatus with cut-away view perspectives. FIG. 9 illustrates a first plane 910 and a second plane 920. For the first plane 910, FIG. 10A provides a point of view from the plane looking towards the handwheel, along the directional arrow illustrated for FIG. 10A. For the second plane 920, FIG. 10B provides a point of view from the plane towards the female contact housing along the directional arrow illustrated for FIG. 10B.

FIG. 10A illustrates a cut-away view towards the front of a ground switch apparatus. The cutaway view of FIG. 10 a illustrates a point of view from the position of plane 910 of FIG. 9. The view of FIG. 10 illustrates front plate 3, switches 12, 13 and 14, switch arms 88, 89, and 90, switch leads 91, 92, and 93, cam 27, and cam indents 84, 94, and 95. Spring 30 applies a force to detent arm 16 and roller 26 towards the radial surface of cam 27. As handwheel 1 is rotated (not illustrated in FIG. 10 a), the cam and indents rotate radially. When one of the three indents is aligned with roller 26, roller 26 is displaced into the indent, as illustrated in FIG. 10A with roller 26 and indent 95. This achieves a “locking” detent to the handwheel in this position. The same locking detent will be felt when roller 26 engages indent 84 and indent 94.

One of switches 12, 13, and 14 may be activated when cam switch tab 103 engages one of switch arms 88, 89 and 94, respectively. In particular, when tab 103 is aligned with a switch arm, the arm is displaced away from the center of the cam and the switch may be activated to provide a signal that the cam is in a particular position. For example, a lifting of a switch arm when the arm is aligned with a tab, or the lowering of a switch arm if the arm is aligned with a corresponding indent (not illustrated in FIG. 10 a), may provide a closed circuit which can enable a signal to be sent to a power distribution unit 130. The signal sent to power distribution unit 130 can indicate the ground switch apparatus is in a particular position associated with that switch (e.g., grounded, ungrounded, engineering test)

FIG. 10B illustrates a cut-away view towards the back of a ground switch apparatus. The view illustrated in FIG. 10B is the view at plane 920 towards the back of the ground switch apparatus. The cutaway view of FIG. 10 B illustrates a portion of male contact plate 69, backplate 71, and the back of male connectors 66, 67, and 68. When a lead screw 33 rotates, nut 56 causes the male contact plate to move away from backplate 71, resulting in male connectors 66, 67, and 68 disengaging the corresponding female connectors that are coupled to a female contact housing.

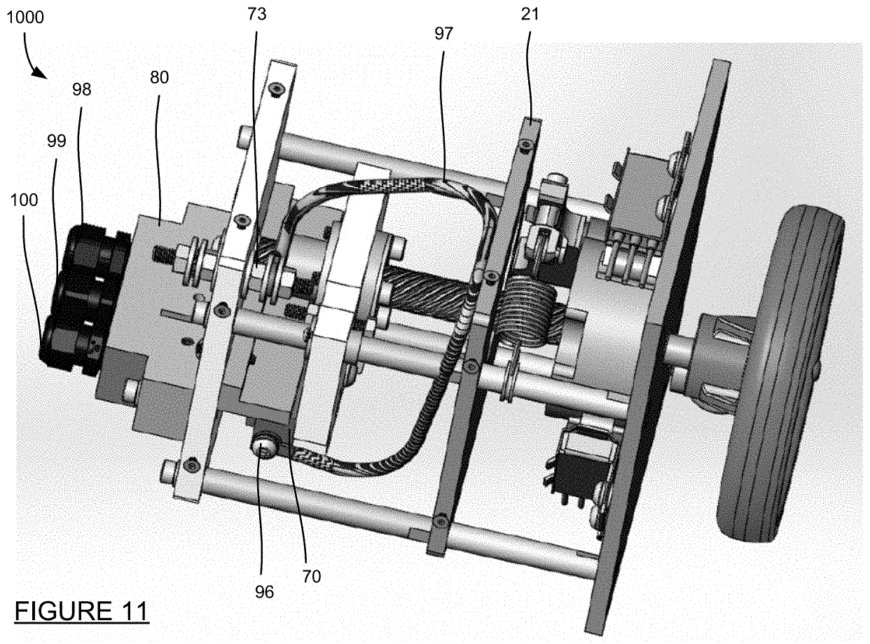

FIG. 11 illustrates a perspective view of a ground switch apparatus having a ground wire. The ground switch apparatus of FIG. 11 includes ground wire 67. Ground wire 67 extends from plate ground contact 73 to ground wire screw 96, which is attached to male contact housing 70. The ground wire 97 may be any wire suitable for grounding a connection applied by live wire connectors 98, 99 and 100 that connect to female contact housing 80. In some instances, ground wire 97 may include a 14-gauge wire.

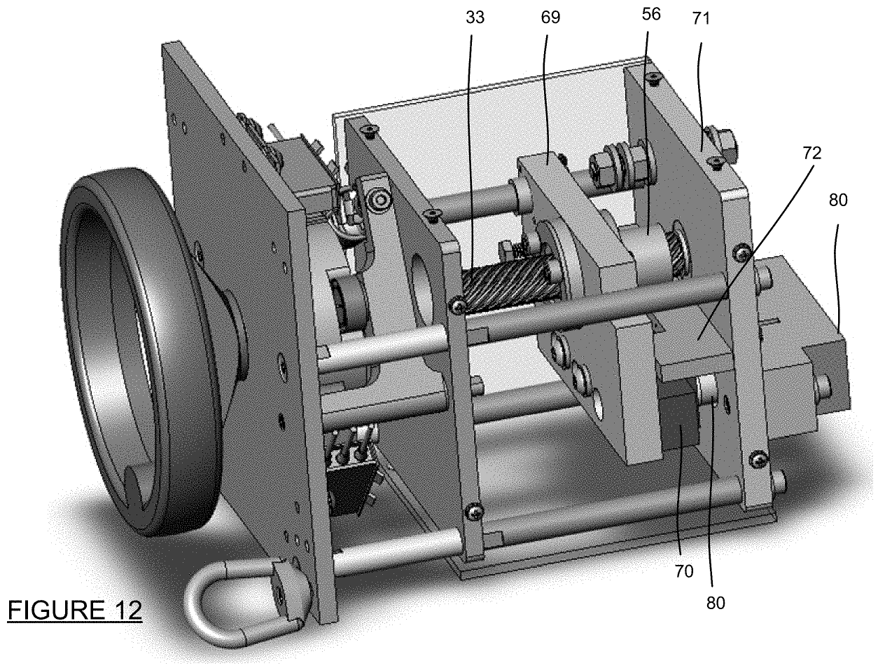

FIG. 12 illustrates a perspective view of a ground switch apparatus in a grounded configuration. The perspective view of FIG. 12 illustrates components of the grounding assembly 140, including male contact plate 69, in a grounded configuration. As such, male contact plate 69 is displaced towards back plate 71 until male contact plate 69 engages and is stopped by backplate shield 72. In this position, male connectors 66-68 coupled to male contact plate 21 engage with and are displaced inside female connectors 74-76, and the ground switch apparatus is in a grounded configuration, providing ground to a power source connected to female contact housing 80.

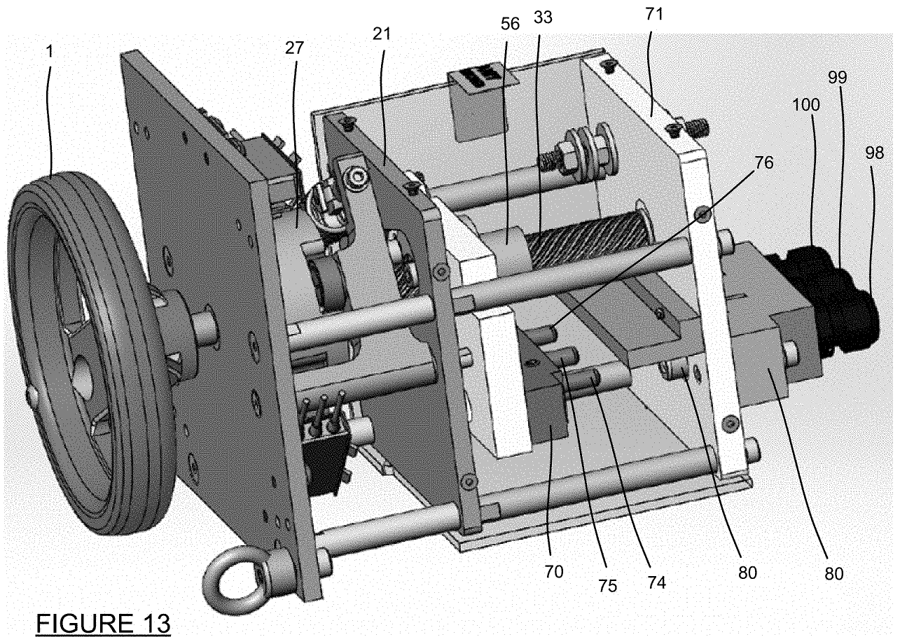

FIG. 13 illustrates a perspective view of a ground switch apparatus in an open circuit configuration. As handwheel 1 is rotated in a particular direction, lead screw 33 turns and drives nut 56 towards handwheel 1 and away from backplate 71. As nut 56 is displaced away from backplate 71, male contact housing 70, male contact plate 69, and male connectors 74-76 also move away from backplate 71 and towards middle plate 21. As shown in FIG. 13, male connectors 74-76 are completely withdrawn and disengaged from female connectors within female contact housing 80. In this configuration, the ground switch apparatus does not provide a ground for a power source connected to connectors 98, 99, and 100.

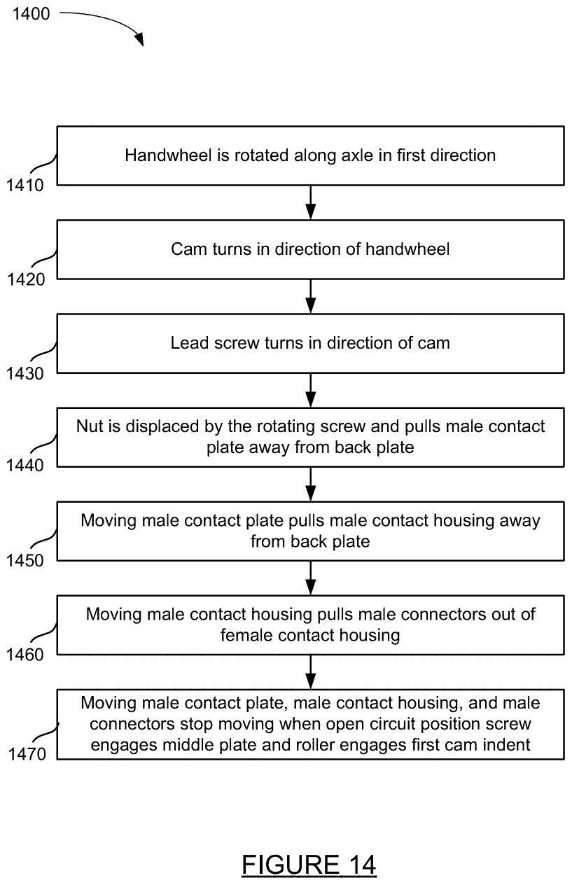

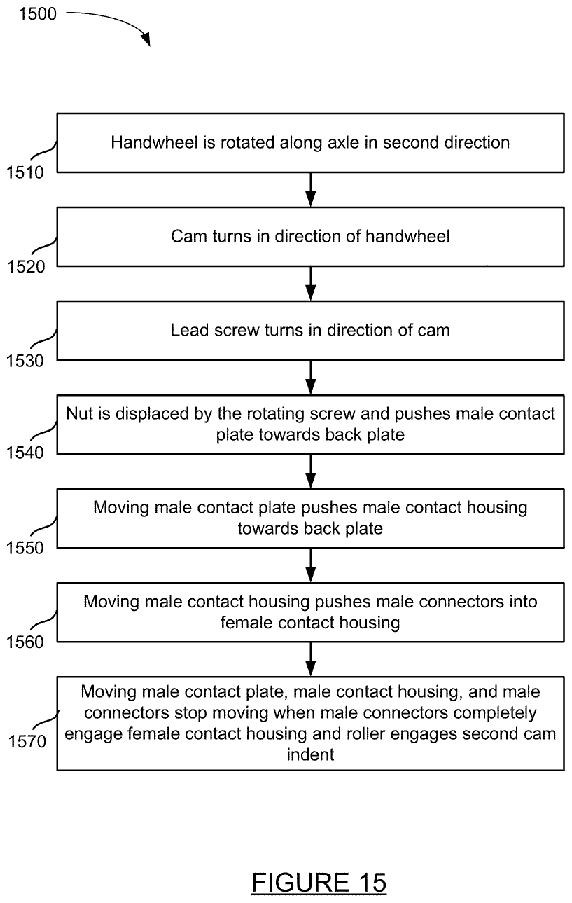

FIGS. 14 and 15 illustrate methods for operating a ground switch apparatus. FIG. 14 is a method for placing the ground switch apparatus in an open circuit configuration. First, the handwheel is rotated along an axle in a first direction at step 1410. Rotating the handwheel causes a cam to turn in the direction of the handwheel at step 1420. A lead screw also turns in the direction of the cam at step 1430. A nut is displaced by the rotating lead screw and pulls a male contact plate away from a back plate at step 1440. The moving male contact plate pulls a male contact housing away from the backplate at step 1450, and the moving male contact housing pulls male connectors away from and disengages a female contact housing with female connectors at step 1460. The moving male contact plate, male contact housing, and male connectors stop moving when an open circuit position screw engages a middle plate and a roller engages a first cam indent at step 1470. At this point, the ground switch apparatus is in an open circuit position and a power source connected to the apparatus is not grounded.

FIG. 15 is a method for placing the ground switch apparatus in a grounded configuration. A handwheel is rotated along an axle in a second direction at step 1510. The second direction may be the opposite radial direction as that described with respect to the method of FIG. 14. A cam turns in the direction of the handwheel and at step 1520 and a lead screw turns in the direction of the cam at step 1530. A nut is displaced by the rotating screw and pushes a male contact plate towards a backplate at step 1540. A moving male contact plate pushes a male contact housing towards the backplate at step 1550. The moving male contact housing pushes male connectors to engage female connectors within a female contact housing at step 1560. A moving male contact plate, male contact housing, and male connectors stop moving when male connectors completely engage the female connectors within the female contact housing and a roller engages a second cam indent at step 1570.

The foregoing detailed description of the technology herein has been presented for purposes of illustration and description. It is not intended to be exhaustive or to limit the technology to the precise form disclosed. Many modifications and variations are possible in light of the above teaching. The described embodiments were chosen to best explain the principles of the technology and its practical application to thereby enable others skilled in the art to best utilize the technology in various embodiments and with various modifications as are suited to the particular use contemplated. It is intended that the scope of the technology be defined by the claims appended hereto.

What is claimed is:

1. A ground switch apparatus, comprising:
a first plate coupled to a screw engagement mechanism, the screw engagement mechanism engaged by a user to turn a screw within the ground switch apparatus;
a second plate having a connection mechanism for connecting to a power source; and
a grounding assembly movably engaging the screw, wherein the second plate includes a receiving mechanism for receiving the first portion of the grounding assembly,
the screw engagement mechanism turning the screw when engaged by a user, the grounding assembly moving towards the back plate or away from the back plate based on the engagement of the screw engagement mechanism by the user, the ground switch apparatus providing a ground circuit for the power source when the receiving mechanism receives the first portion of the grounding assembly.

2. The ground switch apparatus of claim 1, wherein the ground circuit mechanism can withstand providing a ground connection to a 10 kilovolt power source.

3. The ground switch apparatus of claim 1, wherein the ground circuit mechanism can withstand providing a ground connection to a power source with a current of 70 amps.
to

4. The ground switch apparatus of claim 1, wherein the grounding assembly connects to the receiving mechanism using a plurality of pin-and-socket connections, the pin-and-socket connection making a connection to provide a ground circuit for the power source.

5. The ground switch apparatus of claim 1, further comprising a middle plate coupled to the first plate by a first plurality of standoff components and coupled to the second plate by a second plurality of standoff components, the middle plate displaced between the first plate and the second plate, the screw extending through an aperture in the middle plate, the grounding assembly engaging the surface of the middle plate when the ground switch apparatus is configured in an open-circuit position.

6. The ground switch apparatus of claim 5, wherein the first plate, second plate and third plate constructed of materials that do not absorb moisture.

7. The ground switch apparatus of claim 1, wherein the grounding assembly includes a male contact plate, a male contact housing, and a plurality of male connectors, the plurality of male connectors on the grounding assembly engaging a plurality of female connectors on the receiving mechanism when the ground switch mechanism is configured in a grounding position.

8. The ground switch apparatus of claim 1, further including a ground wire extending from the male contact housing to the male contact plate.

9. The ground switch apparatus of claim 8, wherein the receiving mechanism including female connector housing that includes the plurality of female connectors.

10. The ground switch apparatus of claim 1, wherein the grounding assembly includes a nut that engages the screw, the nut displacing the grounding assembly along the screw when the screw rotates as a result of the user engaging the screw engagement mechanism.

11. The ground switch apparatus of claim 10, wherein the screw engagement mechanism includes a handwheel, wherein the screw displaces the grounding mechanism towards the second plate to configure the ground switch mechanism in a grounding position when the handwheel is turned in a first direction, the screw displacing the grounding mechanism towards the first plate to configure the ground switch mechanism in an open circuit position when the handwheel is turned in a second direction.

12. The ground switch apparatus of claim 1, further comprising a cam coupled to the screw, the cam rotating with the screw and including a plurality of indents on a surface of the cam, a first indent of the plurality of indents engaging a roller coupled to a detent arm when the grounding assembly is in a grounding position and a second indent of the plurality of indents engaging the roller coupled to the detent arm when the grounding assembly is in an open circuit position.

13. The ground switch apparatus of claim 1, further comprising a plurality of switches, wherein each of the plurality of switches is coupled to the cam, wherein a first switch of the plurality of switches is configured to provide a signal when the cam is in a first position associated with a grounded state and a second switch of the plurality of switches is configured to provide a signal when the cam is in a second position associated with an open circuit state.

14. The ground switch apparatus of claim 13, wherein the cam has a third indent and a third switch coupled to the cam, the third switch of the plurality of switches configured to provide a signal when the cam is in a third position associated with an engineering test state.

15. The ground switch apparatus of claim 1, wherein the plurality of switches include sealed switches, at least one or more the plates are coupled together using standoff components and screws, wherein the screws are passivated, the first plate being anodized aluminium and the second plate being plastic, and wherein at least two or more plastic bushings are used to prevent contact between two metal surfaces within the ground switch apparatus, the switches, the ground switch apparatus being marine environment compatible based on the plates, screws, and bushings.

16. The ground switch apparatus of claim 15, wherein the ground switch apparatus is placed within a power distribution unit, the plurality of switches providing a signal to the power distribution unit based on the position of the cam in the ground switch apparatus.
